(19) United States
(12) Patent Application Publication
(10) Pub. No.: US 2021/0222800 A1
(43) Pub. Date: Jul. 22, 2021

(54) DEVICE FOR FASTENING HOSES

(71) Applicant: Walter Stauffenberg GmbH & Co. KG, Werdohl (DE)

(72) Inventor: Ulrich Stefan KOENIG, Herscheid (DE)

(73) Assignee: Walter Stauffenberg GmbH & Co. KG, Werdohl (DE)

(21) Appl. No.: 16/769,002

(22) PCT Filed: Feb. 15, 2019
(86) PCT No.: PCT/EP2019/053823

§ 371 Date: Jun. 2, 2020

(30) Foreign Application Priority Data
Mar. 7, 2018 (EP) 18160529.6

(51) Int. Cl. F16L 3/10; F16L 3/237

(52) U.S. Cl. CPC F16L 3/1091; F16L 3/237

(57) ABSTRACT

A device for fastening hoses includes two fastening parts which can be connected to one another and which, in the assembled state, form a passage having an elliptical, in particular circular cross-section, wherein at least one radially encircling groove having an in particular edge-free cross-section is arranged in the inner lateral surface of the passage.

The invention relates to a device for fastening hoses, in accordance with the preamble of claim 1.

For fastening pipes and hoses, so-called clamps are used, which regularly comprise a clamp body that is produced from a thermoplastic or elastomer plastic or also from metal. In this regard, the clamp body is frequently formed from two fastening parts that can be connected with one another and form a passage for holding the pipe or the hose in the assembled state. In Germany, such clamps are standardized in accordance with DIN 3015:1999-01. For fastening pipes, a ribbed construction is particularly used. In this regard, the inner surface of the passage is provided with radially circumferential ribs so as to increase the holding forces. The pipe being held is held between the rib contact surfaces, as the result of which the surface pressure is increased. The pipe is thereby clamped in the clamp.

For fastening hoses, a so-called H-profile is used. In this regard, the passage is configured as a smooth hollow cylinder throughout. This embodiment is supposed to guide a hose that is being held but not to clamp it.

The “RI” embodiment with an elastomer insert is used to reduce vibrations when holding pipes. In this regard, an elastomer insert that has a passage for holding the pipe is inserted into the clamp passage. Since the passage of the elastomer insert is regularly configured to be a smooth hollow cylinder, this embodiment can also be used for hoses.

In practice, it has been shown that users of clamps according to DIN 3015 do not just “guide” hoses but also wish to “fix them in place,” and for this reason, the ribbed design is also used for fastening hoses. In this regard, however, damage to the hoses can occur due to hose movements and due to the ribs, which are designed with sharp edges for holding pipes. In order to prevent such damage to hoses, it is not permissible to fix hoses in place, in accordance with the provisions of the professional organization.

This is where the invention takes its start. The invention is based on the task of making available a device for fastening hoses, which allows fixation of hoses while simultaneously preventing damage. According to the invention, this task is accomplished by means of the characteristics of the characterizing part of claim 1.

With the invention, a device for fastening hoses is made available, which allows fixation of hoses while simultaneously avoiding damage. Due to the fact that at least one radially circumferential groove having an arc-shaped, in particular an edge-free cross-section is arranged in the inner mantle surface of the passage, damage is prevented even in the case of hose movement. The hose held in the passage lies against the inner mantle surface of the passage without being subjected to a partially increased surface pressure. At the same time, the flexible hose material lies against the contour of the at least one circumferential groove that forms an undercut, and thereby a shape-fit connection between hose and clamp is brought about. The hose is thereby fixed in place in the fastening device both axially and radially.

In a further development of the invention, at least two circumferential grooves are arranged parallel to one another. As a result, the shape fit between the hose being held and the fastening device is increased.

In an embodiment of the invention, the inner mantle surface of the passage formed by the fastening parts is configured to be essentially smooth, at least outside of the surface provided with the at least one groove. As a result, possible wear of the hose during hose movements is counteracted. Preferably, the inner mantle surface of the passage, situated between the grooves, is also configured to be smooth.

In a further embodiment of the invention, the transition of the end faces of the fastening parts to the passage is rounded off and, in particular, is configured to be free of edges. As a result, damage to a hose held by the passage is further counteracted.

In a further development of the invention, the at least one groove is provided with a profile and/or with texturing, at least in certain regions. As a result, the shape fit between hose and fastening device is further improved.

In an embodiment of the invention, the fastening parts each have an insert part, which insert parts form an insert in the assembled state of the fastening parts, which insert forms the passage provided with the at least one groove. In this regard, the insert parts are preferably produced from a material that is different from the material of the fastening parts, in particular a more elastic material. Because of the elastic configuration of the insert parts, the shape fit between them and the hose held by the passage is supported. In this regard, the fastening parts produced from a material that is preferably more non-elastic can be designed to be more robust. Particularly preferably, the insert parts are formed from a thermoplastic elastomer.

In a further embodiment of the invention, the two insert parts of the insert form a hollow-cylindrical base body, on the outer mantle surface of which two radially circumferential ridges are formed at a distance from one another, between which ridges a radial center ridge of the fastening parts engages. As a result, the insert is reliably held in the device.

In a further development of the invention, the circumferential ridges are provided with recesses that are arranged at a distance from one another, and thereby a comb-like ridge shape is formed. As a result, the contact surface of the circumferential ridges against the passage formed by the fastening parts is reduced, and thereby the transfer of sound is reduced. In this regard, the recesses can all or partially be continued to project into the base body, and thereby the material thickness of the base body is reduced in the region of these recesses.

In an embodiment of the invention, the inside diameter of the center ridge of the fastening parts is smaller than the diameter of the outside mantle surface of the base body, wherein the ridges of the insert that project outward lie against the passage on both sides of the center ridge. As a result, the inner region of the outer mantle surface of the insert, which is situated between the ridges that project outward, does not lie against the center ridge of the passage, and for this reason no transfer of vibrations or sound takes place in this region. The sound-reducing and vibration-reducing properties are thereby improved.

In an embodiment of the invention, the insert parts are configured to be identical, wherein preferably, a bore is arranged on one side in the cross-section of a ridge that projects outward, and a pin is arranged on the opposite side, in each instance, so that each insert part has two pins arranged diagonally relative to one another and two bores arranged diagonally relative to one another, in such a manner that a plug-in connection of the two insert parts is made possible. In this way, reliable fixation of the two insert parts is achieved.

In a further development of the invention, the insert is produced from an elastomer. Good results were also achieved when using a thermoplastic natural rubber. This material has clearly improved material properties with regard to elasticity and resistance to external influences as compared with comparable vulcanized rubber products.

In an embodiment of the invention, the two fastening parts are configured to be identical at least on their sides that face one another, but preferably as a whole. As a result, the production effort is reduced. In the case of an identical configuration of the fastening parts, warehousing expenditures are furthermore minimized.

In a further embodiment of the invention, the fastening parts are formed essentially of plastic. As a result, cost-advantageous production of fastening parts that have a long useful lifetime and are resistant to corrosion is made possible. Preferably, the fastening parts are produced from an elastic plastic, preferably from a thermoplastic elastomer (TPE) or a similar elastic material.

During placement of insert parts made of elastic material that form the passage, the fastening parts can also be produced from metal, in particular aluminum, steel or stainless steel.

Other further developments and embodiments of the invention are indicated in the remaining dependent claims. An exemplary embodiment is shown in the drawing and described in detail below. The figures show:

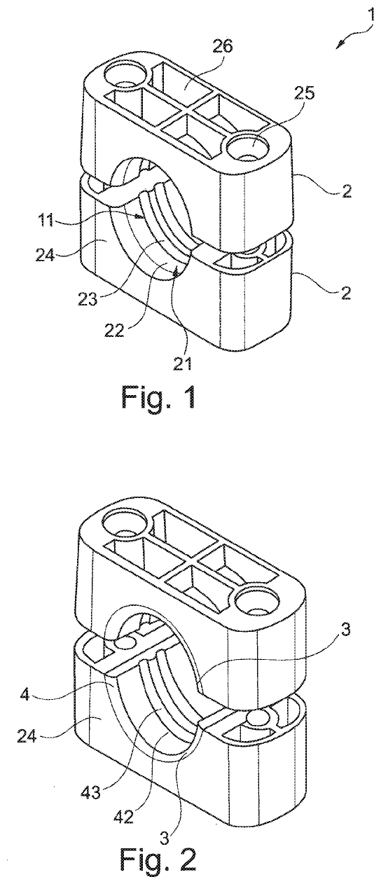

FIG. 1 the schematic representation of a device for fastening hoses in a spatial representation;

FIG. 2 the representation of a device for fastening hoses in a further embodiment;

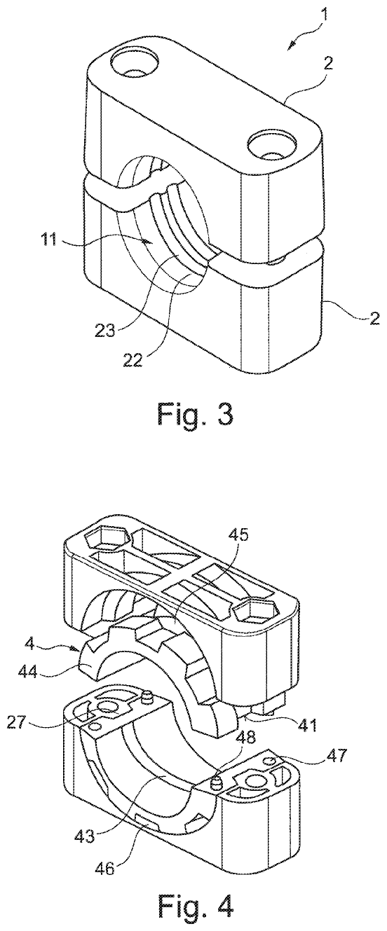

FIG. 3 the representation of a device for fastening hoses in a third embodiment, and

FIG. 4 the schematic representation of a device for fastening hoses in a fourth embodiment.

The device for fastening hoses that was selected as an exemplary embodiment is configured as a block-shaped hose clamp 1, which is composed of two identically structured hose clamp halves 2.

The hose clamp halves 2 are produced from polypropylene (PP) in the exemplary embodiment, and have a base body that is configured essentially in block shape, into the center of which, in the transverse direction, a semi-cylindrical recess 21 is formed. Two radially circumferential ridges 23 having an arc-shaped cross-section are formed into the inner mantle surfaces 22 of the hose clamp halves 2 delimited by the recesses 21, at a distance from one another. The transition between the grooves 23 and the inner mantle surface 22 are configured to be rounded off, and thereby an edge-free, smooth surface is formed. The respective transition of the inner mantle surface 22 formed by the recess 1 to the end faces 24 of the hose clamp halves 2 are also rounded off and, in particular, configured to be free of edges.

Two bores 25 are introduced into the hose clamp halves 2 on both sides of the recess 21, lying opposite one another. The bores 25 serve for passing through screws for bracing the two hose clamp halves 2 against a hose—not shown—that is held in the passage 11 formed by the recesses 21. Furthermore, recesses 26 are introduced between the bores 25. These recesses 26 serve to save material and to reduce the weight of the hose clamp halves 2. In the exemplary embodiment according to FIG. 3, the hose clamp halves 2 are produced from solid elastomer. In this regard, no recesses are introduced for reasons of stability.

In the exemplary embodiment according to FIG. 2, the hose clamp 1 holds an insert 3 that forms the passage 11 of the hose clamp 1. In the exemplary embodiment, the insert 3 is produced from a thermoplastic elastomer and is composed of two insert halves 4, which are configured to be identical. The insert halves 4 each consist of a base body 41 in the shape of half of a hollow cylinder, into the inner mantle surface 42 of which two grooves 43 are formed parallel to one another. On the end side, the inner mantle surfaces 42 of the insert halves 4 are configured to be rounded off radially outward. In this regard, the respective insert half 4 preferably lies against the end face 24 of the respective hose clamp half 2 in edge-free manner.

In the exemplary embodiment according to FIG. 4, the hose clamp 1 again holds an insert 3 that forms the passage 11 of the hose clamp 1 and is composed of two insert halves 4 that are configured to be identical, and are produced from a thermoplastic elastomer. The insert halves 4 each consist of a base body 41 in the form of half of a hollow cylinder, into the inner mantle surface 42 of which two grooves 43 are formed parallel to one another. On the outer mantle surfaces of the insert halves 4, two circumferential ridges 44 that project radially outward are formed on the edge side, lying opposite one another, between which a groove 45 is formed. Recesses 46 are introduced into the circumferential ridges 44, at regular intervals from one another, and thereby a comb-like form of the circumferential ridges 44 is formed.

For a shape-fit connection of the two insert halves 4, a bore 47 is arranged in the cross-section of the two identically configured insert halves 4 on one side, in the region of the crosspiece 44 that projects outward, in each instance, and a pin 48 is arranged on the opposite side, so that each of the insert halves 4 has two pins 48 arranged diagonally relative to one another and two bores 47 arranged diagonally relative to one another. In the assembled state of the insert 3, the pins 48 of one insert half 4 engage into a bore 47 of the insert half 4 arranged to lie opposite, in each instance.

The insert 3 is inserted into the recesses 21 of the hose clamp halves 2 in such a manner that the two circumferential ridges 44 lie against the recesses 21 on both sides of a center ridge 27 arranged on the hose clamp halves. In this regard, the inside diameter of the center ridge 27 of the hose clamp 1 formed by the hose clamp halves 2 can preferably be selected to be smaller than the diameter of the outer mantle surface of the base body 41 of the insert 3 formed by the insert halves 4. In this case, the insert 3 lies against the hose clamp 1 only with the ridges 44, the contact surface of which is reduced by the recesses 46. The contact surface of the insert 3 with the hose—not shown—that is to be held is formed by the inner mantle surfaces of the base bodies 41 of the inserts 4 that are provided with the grooves 43.

On the end side, the inner mantle surfaces 42 of the insert halves 4 are once again configured to be rounded off radially outward. (This rounding off is not shown in the representation in FIG. 4, which is merely schematic).

1. A device for fastening hoses, comprising two fastening parts that can be connected with one another, which form a passage having an elliptical, in particular a circular cross-section, in the assembled state, wherein at least one radially circumferential groove (23, 43) having an arc-shaped, in particular an edge-free, cross-section is arranged in the inner mantle surface (22, 42) of the passage (11).

2. The device according to claim 1, wherein at least two circumferential grooves (23, 43) are arranged parallel to one another.

3. The device according to claim 1, wherein the inner mantle surface (22, 42) of the passage (11) formed by the fastening parts (2) is configured to be essentially smooth, at least outside of the inner mantle surface (22, 42) provided with the at least one groove (23, 43).

4. The device according to claim 1, wherein the transition of the end faces (24) of the fastening parts (2) to the passage (11) is rounded off and, in particular, is configured to be free of edges.

5. The device according to claim 1, wherein the at least one groove (23, 43) is provided with a profile and/or with texturing, at least in certain regions.

6. The device according to claim 1, wherein the fastening parts (2) each have an insert part (4), which insert parts (4) form an insert (3) in the assembled state of the fastening parts (2), which insert forms the passage (11) provided with the at least one groove (43).

7. The device according to claim 6, wherein the insert parts (4) are produced from a material that is different from the material of the fastening parts (2), in particular a more elastic material.

8. The device according to claim 7, wherein the insert parts (4) are formed from a thermoplastic elastomer.

9. The device according to claim 6, wherein the two insert parts (4) of the insert (3) form a hollow-cylindrical base body (41), on the outer mantle surface of which two radially circumferential ridges (44) are formed at a distance from one another, between which ridges (44) a radial center ridge (27) of the fastening parts (2) engages.

10. The device according to claim 9, wherein the circumferential ridges (44) are provided with recesses (46) that are arranged at a distance from one another, and thereby a comb-like ridge shape is formed.

11. The device according to claim 6, wherein the insert parts (4) are configured to be identical.

12. The device according to claim 1, wherein the fastening parts (2) are configured to be identical.

13. The device according to claim 1, wherein the fastening parts (2) are produced from an elastic plastic, preferably from a thermoplastic elastomer (TPE).
